(19) United States
(12) Patent Application Publication
(10) Pub. No.: US 2015/0251271 A1
(43) Pub. Date: Sep. 10, 2015

(54) DIFFUSION WELDING METHOD

(71) Applicant: SOCIÉTÉ TECHNIQUE POUR L'ENERGIE ATOMIQUE TECHNICATOME, Villiers Le Bacle (FR)

(72) Inventors: Laurent Candillier, Simiane (FR); Thomas Mignot, Aix en Provence (FR)

(21) Appl. No.: 14/438,195

(22) PCT Filed: Nov. 6, 2013
(86) PCT No.: PCT/EP2013/073103

§ 371 Date: Apr. 23, 2015

(30) Foreign Application Priority Data
Nov. 8, 2012 (FR) 12/03004

(51) Int. Cl. B23K 20/02; B23K 20/00; B23K 20/233; F28F 3/08

(52) U.S. Cl. CPC B23K 20/02; F28F 3/08; B23K 20/002; B23K 20/233

(57) ABSTRACT

A diffusion welding method is provided. The method includes at least a) obtaining metal plates, b) stacking a plurality of the plates obtained in step a) in order to obtain a stack, and c) diffusion welding applied to the stack obtained in step b) so as to obtain a set of welded plates. The plates obtained in step a) comprise a biphasic titanium alloy, and during step c), the stack is heated to an assembling temperature comprised between a minimum temperature allowing bonding between the plates of the set of welded plates on the one hand, and a maximum temperature past which the alloy becomes monophasic on the other hand, the heating of the stack having a duration shorter than the maximum duration beyond which the alloy of the plates of the set of welded plates comprises grains with a grain size index strictly lower than 6. A corresponding heat exchanger is also provided.

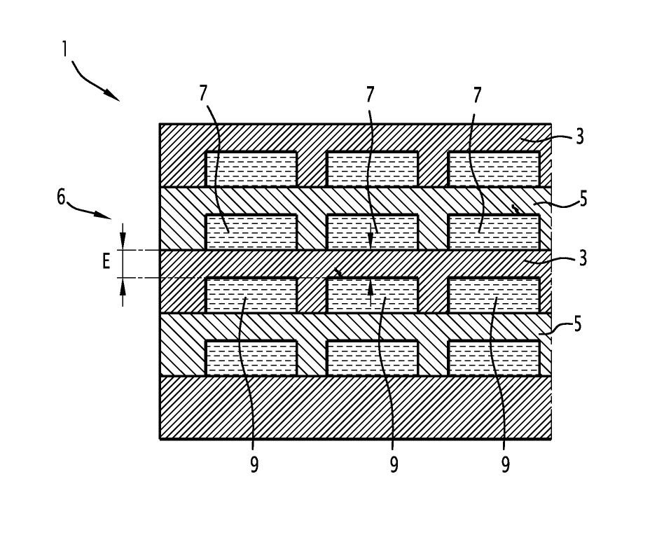

The present invention relates to a diffusion welding method comprising at least the following steps:
a) obtaining metal plates,
b) stacking a plurality of the plates obtained in step a) in order to obtain a stack (6), and
c) diffusion welding applied to the stack (6) obtained in step b) so as to obtain a set of welded plates.

The method for example targets the production of plate heat exchangers.

Diffusion welding is a solid phase welding method in which the parts kept in contact under a given pressure are brought to a predefined temperature for a controlled length of time. These operating conditions lead to local plastic surface deformations, close contact and the migration of atoms between the elements, which thereby makes it possible to obtain continuity of the material.

This method is particularly interesting, since plates assembled in this way are closely connected, including in the heat exchange zones. The material continuity on the periphery of the set of welded plates facilitates the machining or welding of the set of welded plates to finalize the exchanger.

### BACKGROUND

The most traditional solution to perform diffusion welding of a stack of plates consists of applying a unified axial stress on the plates, i.e., along a single axis perpendicular to the plates, in a thermal oven with a sufficient vacuum.

Another solution consists of assembling a stack of plates by using a hot isostatic pressing furnace. The stack of plates to be assembled is then placed in a tight and deformable enclosure in which there is a sufficient vacuum. The pressing furnace provides the necessary heat and welding stress owing to the pressurized gas that it contains.

Such methods make it possible to obtain stacks of plates with very large dimensions, for example 1 m×1 m×3 m.

### SUMMARY OF THE INVENTION

However, the known diffusion welding methods do not make it possible to weld exchangers with bulky plates, for example with a volume greater than 3×3×1 m³, without their mechanical characteristics being substantially altered. More specifically, if these known methods are applied to the production of bulky exchangers, all or some of the following properties of the obtained exchanger are insufficient: mechanical strength, corrosion resistance, lifetime of the assembly.

An object of the invention is to provide a method making it possible to manufacture a bulky plate heat exchanger, the exchanger having a good mechanical strength, corrosion resistance and lifetime of the assembly.

A method of the type described above is provided, in which:
the plates obtained in step a) comprise a biphasic titanium alloy, and
during step c), the stack is heated to an assembling temperature comprised between a minimum temperature allowing bonding between the plates of the set of welded plates on the one hand, and a maximum temperature past which the alloy becomes monophasic on the other hand, the heating of the stack having a duration shorter than a maximum duration beyond which the alloy of the plates of the set of welded plates comprises grains with a grain size index strictly lower than 6.

According to specific embodiments, the method includes one or more of the following features, considered alone or according to any technically possible combination(s):
in step a), the biphasic titanium alloy comprises TA6V, the two phases being α-phase titanium and β-phase titanium;
in step a), the biphasic titanium alloy comprises Ti8Mn or Ti7A14Mo;
in step c), the assembling temperature to which the stack is brought is substantially comprised between 700° C. and 950° C.;
in step c), the heating duration is substantially comprised between 1 hour and 5 hours;
during step c), two adjacent plates of the stack undergo a contact pressure comprised1 between 10 and 50 bars;
in step b), the plates obtained in step a) are stacked to obtain a plurality of stacks of plates, each stack having dimensions such that it is able to hold between two parallel planes separated from one another by less than 200 mm, preferably between two parallel planes separated from one another by a distance comprised between 100 and 1000 mm; in step c), each stack obtained in step b) is diffusion welded to obtain a plurality of sets of welded plates; and in step d), the sets of welded plates obtained in step c) are assembled;
the method further comprises a step d) of obtaining a plate heat exchanger from the set of welded plates obtained in step c).

The invention also relates to a plate heat exchanger comprising a set of stacked and diffusion welded metal plates, the exchanger being characterized in that:
the set of plates comprises a biphasic titanium alloy, and
the set of welded plates comprises grains with a grain size index greater than or equal to 6.

### BRIEF SUMMARY OF THE DRAWINGS

The invention will be better understood upon reading the following description, provided solely as an example, and done in reference to the appended Figure, which is a partial sectional view of a plate heat exchanger according to an embodiment of the invention.

The method described below makes it possible to obtain an exchanger 1 shown diagrammatically in the Figure.

### DETAILED DESCRIPTION

The exchanger 1 comprises stacked primary plates 3 and secondary plates 5. The alternating of the primary plates 3 and the secondary plates 5 is for example single, i.e. each primary plate 3 is situated between two secondary plates 5. The primary plates 3 and the secondary plates 5 are for example substantially horizontal.

Only two plates 3, 5 of each type are shown in the Figure. However, the exchanger 1 advantageously comprises a much higher number of plates. The dimensions of the exchanger 1 are for example larger than 1m by 3m horizontally, and the height of the exchanger 1 is greater than 1m.

Each primary plate 3 defines, jointly with the secondary plate 5 situated below it, a plurality of channels 7 for the circulation of a primary fluid.

Each primary plate 3 is for example made from TA6V alloy.

Each primary plate 3 is diffusion welded to the secondary plates 5 situated above and below it.

The secondary plates 5 are advantageously similar to the primary plates 3 and will not be described in detail. Each secondary plate 5 defines, jointly with the primary plate 3 situated below it, a plurality of channels 9 for the circulation of a secondary fluid.

The primary plates 3 and the secondary plates 5 have any thickness. According to one particular embodiment, the plates 3, 5 are configured so that the minimum distance E between the primary fluid and the secondary fluid within the exchanger 1 is comprised between 0.5 mm and 2 mm.

The secondary fluid and the primary fluid are designed to exchange heat via the primary plates 3 and the secondary plates 5 of the exchanger 1.

A method for obtaining the exchanger 1 according to an embodiment of the invention will now be described. The method comprises at least the following four steps.

A first step consists of obtaining the primary plates 3 and the secondary plates 5. The primary plates 3 and the secondary plates 5 for example have the shapes and composition described above.

In a second step, the primary plates 3 and the secondary plates 5 obtained in the first step are stacked, for example as described above, so as to obtain the stack 6 shown in the Figure.

In a third step, the stack 6 obtained in the second step is diffusion welded in order to obtain a set of welded plates.

It is difficult, without being restrictive, to definitively specify the temperature and duration conditions of the third step. These parameters in fact depend both on the composition and the geometry of the plates 3, 5. The temperature and duration conditions also depend on one another.

One skilled in the art is nevertheless able to determine these conditions, for the stack 6, through simple tests, by bringing the stack 6 to an assembly temperature comprised between a minimum temperature, approximately the annealing temperature, allowing bonding between the plates 3, 5 of the set of welded plates on the one hand, and a maximum temperature beyond which the alloy becomes monophasic on the other hand. The aforementioned maximum temperature is for example the beta transus of the TA6V alloy minus 20° C. The beta transus being approximately equivalent to 950° C., said maximum temperature is approximately 930° C.

The duration of the heating of the stack 6 is adjusted to a value below a maximum duration past which the alloy of the plates of the set of welded plates comprises grains having a grain size index greater than or equal to 6.

The grain size index is for example defined by standard ASTM E112.

As an example, the stack 6 is brought to an assembling temperature substantially comprised between 700° C. and 930° C., for example approximately 900° C. This temperature is high enough to allow the primary plates 3 and the secondary plates 5 to be bonded to one another. The assembling temperature is low enough for the α and β phases to remain stable, i.e. for their respective mass fractions in the plates 3, 5 not to be substantially altered by the diffusion welding step. “Not substantially modified” means that the mass fractions of the α and β phases practically do not change.

Between the beginning and the end of the third step, the value of the grain size index of the alloy advantageously rises by less than 4 units, preferably less than 3 units.

The assembling temperature is reached owing to heating of the stack 6. The heating duration is substantially comprised between 1 hour and 5 hours, for example approximately 3 hours. Thus, the heating has a short enough duration so that, under the aforementioned temperature conditions, the grains of the set of welded plates have a grain size index greater than or equal to 6.

Advantageously, during the third step, the plates 3, 5 of the stack 6 undergo a contact pressure comprised between 10 and 50 bars, for example approximately 15 bars. The pressure is applied using a method known in itself, for example using a press. The pressure exerted is for example vertical.

In a fourth step, the exchanger 1 is obtained from the set of welded plates resulting from the third step. This for example involves adding water tanks for the primary and secondary fluids, temperature sensors, or other elements known by those skilled in the art to complete a plate exchanger.

Owing to the features of the method described above, a bulky plate exchanger 1, for example with a volume greater than or equal to 3×1×1 m³, is easily obtained. The set of welded plates has grains with a grain size index greater than or equal to 6. Owing to the stability of the α and β phases of the alloy of the plates 3, 5, the appearance of metallurgical phases making the plates more fragile is limited. Thus, the exchanger 1 has good metallurgical characteristics, in particular mechanical strength, corrosion resistance and lifetime.

We will now briefly describe a second method according to a second embodiment of the invention constituting one alternative of the method embodiment described above. The second method embodiment is similar to the process described above and makes it possible to obtain the exchanger 1 as described above. The similar steps or features will not be described again.

The second method embodiment differs by the following features.

During the second step, the plates 3, 5 obtained in the first step are stacked in order to obtain a plurality of stacks of plates 3, 5. The stacks of said plurality are similar to the stack 6 shown in the Figure.

Each stack of the plurality has dimensions such that it is capable of holding between two arbitrary parallel planes separated from one another by less than 200 mm, preferably between two parallel planes separated from one another by a distance comprised between 100 mm and 1000 mm.

In the third step, each stack obtained in the second step is diffusion welded in order to obtain a plurality of sets of welded plates. The welding is similar to that described above.

In the fourth step, the sets of welded plates obtained in the third step are assembled in order to obtain the exchanger 1.

Aside from the advantages already mentioned above, the second method further makes it possible to obtain even bulkier exchangers.

1-11. (canceled)

12. A diffusion welding method comprising:
a) obtaining metal plates comprising a biphasic titanium alloy,
b) stacking a plurality of the plates obtained in step a) in order to obtain a stack, and
c) diffusion welding applied to the stack obtained in step b) so as to obtain a set of welded plates,
during step c), the stack being heated to an assembling temperature between a minimum temperature allowing bonding between the plates of the set of welded plates on the one hand, and a maximum temperature past which the alloy becomes monophasic on the other hand, the heating of the stack having a duration shorter than a maximum duration beyond which the alloy of the plates of the set of welded plates comprises grains with a grain size index strictly lower than 6.

13. The method as recited in claim 12 further comprising a step d) of obtaining a plate heat exchanger from the set of welded plates obtained in step c).

14. The method as recited in claim 13 wherein the dimensions of the exchanger are for example larger than 1m by 3m horizontally, and the height of the exchanger is greater than 1m.

15. The method as recited in claim 13 wherein the plates are configured so that the minimum distance between a primary fluid and a secondary fluid within the exchanger is comprised between 0.5 mm and 2 mm.

16. The method as recited in claim 12 wherein, in step a), the biphasic titanium alloy comprises TA6V, the two phases being α-phase titanium and β-phase titanium.

17. The method as recited in claim 12 wherein, in step a), the biphasic titanium alloy comprises Ti8Mn or Ti7A14Mo.

18. The method as recited in claim 12 wherein, in step c), the assembling temperature to which the stack is brought is comprised between 700° C. and 950° C.

19. The method as recited in claim 12 wherein, in step c), the heating duration is comprised between 1 hour and 5 hours.

20. The method as recited in claim 12 wherein during step c), two adjacent plates of the stack undergo a contact pressure comprised between 10 and 50 bars.

21. The method as recited in claim 12 wherein:
in step b), the plates obtained in step a) are stacked to obtain a plurality of stacks of plates, each stack having dimensions such that it is able to hold between two parallel planes separated from one another by less than 200 mm,
in step c), each stack obtained in step b) is diffusion welded to obtain a plurality of sets of welded plates, and
in step d), the sets of welded plates obtained in step c) are assembled.

22. The method as recited in claim 21 wherein each stack has dimensions such that it is able to hold between two parallel planes separated from one another by a distance comprised between 100 and 1000 mm.

23. A plate heat exchanger comprising:
a set of stacked and diffusion welded metal plates, the set of plates comprising a biphasic titanium alloy, the set of welded plates comprises grains with a grain size index greater than or equal to 6.
